(19) United States
(12) Patent Application Publication
(10) Pub. No.: US 2021/0316990 A1
(43) Pub. Date: Oct. 14, 2021

(54) MANUFACTURING METHOD OF BORON NITRIDE NANOMATERIAL AND BORON NITRIDE NANOMATERIAL, MANUFACTURING METHOD OF COMPOSITE MATERIAL AND COMPOSITE MATERIAL, AND METHOD OF PURIFYING BORON NITRIDE NANOMATERIAL

(71) Applicants: Hitachi Metals, Ltd., Minato-ku, Tokyo (JP); TEKNA Plasma Systems Inc., Sherbrooke, Quebec (CA)

(72) Inventor: Makoto OKAI, Kumagaya-shi, Saitama (JP)

(21) Appl. No.: 17/270,207

(22) PCT Filed: Nov. 9, 2019
(86) PCT No.: PCT/JP2019/035695

§ 371 Date: Feb. 22, 2021

(30) Foreign Application Priority Data
Oct. 29, 2018 (JP) 2018-203104

(51) Int. Cl. C01B 21/064; C08K 3/38; C22C 1/02; C22C 21/00

(52) U.S. Cl. CPC C01B 21/0648; C08K 3/38; C22C 1/026; C22C 21/00; C08K 2003/385; C01P 2002/85; C01P 2002/54; C08K 2201/011; C01P 2004/04

(57) ABSTRACT

A method of manufacturing a boron nitride nanomaterial, in which boron can be removed more certainly from a boron nitride composition comprising boron that is manufactured using, for example, the thermal plasma vapor growth method. A method of manufacturing a boron nitride nanomaterial comprising: a nanomaterial producing step of producing a boron nitride nanomaterial in which a boron grain(s) is included in a boron nitride fullerene; an oxidation treatment step of forming boron oxide on at least a surface layer of the boron grain(s) by exposing the boron nitride nanomaterial to an oxidizing environment; and a mechanical shock imparting step of applying a mechanical shock for removing the boron grain(s) from the boron nitride nanomaterial that has undergone the oxidation treatment step, while the boron nitride nanomaterial is immersed in a solvent that dissolves the boron oxide.

### TECHNICAL FIELD

The present invention relates to, when a boron nitride nanomaterial having a boron nitride fullerene is produced in a state where a boron grain(s) is included in the boron nitride fullerene, a method of obtaining a boron nitride nanomaterial in which the included boron grain(s) is removed.

### BACKGROUND ART

Boron nitride nanotubes (BNNTs) are a nanofiber material with a similar structure as that of carbon nanotubes (CNTs), and are known as a material that can be utilized as a filler of composite materials with polymeric materials, metallic materials, or the like. In addition, it has been reported that the boron nitride nanotubes can be manufactured via the arc discharge method, vapor growth method, CNT substitution method, ball milling method, laser ablation method, etc.

It has been difficult to efficiently produce boron nitride nanotubes on a large scale by these manufacturing methods, but in recent years, manufacturing methods by the thermal plasma vapor growth method have been proposed, as described in Non Patent Literatures 1 and 2. It is expected that these methods will enable an efficient, large scale production of boron nitride nanotubes.

### CITATION LIST

### Non Patent Literature

Non Patent Literature 1:

Hydrogen-Catalyzed, Pilot-Scale Production of Small-Diameter Boron Nitride Nanotubes and Their Macroscopic Assemblies, ACS NANO, vol.8, no.6, pp. 6211-6220 (2014)

Non Patent Literature 2:

Hydrogen-Catalyzed, Pilot-Scale Production of Small-Diameter Boron Nitride Nanotubes and Their Macroscopic Assemblies, ACS NANO, vol.8, no.6, pp. 6211-6220 (2014), Supporting Information

### SUMMARY OF INVENTION

### Technical Problem

As described in Non Patent Literatures 1 and 2, when boron nitride nanotubes are manufactured using the thermal plasma vapor growth method, boron nitride nanotubes grow from the boron that has been precipitated in a space, and boron nitride fullerenes (BNFs), which have similar properties as boron nitride nanotubes, is also formed around boron. Accordingly, boron nitride nanomaterials having boron nitride fullerenes that include boron (B) and boron nitride nanotubes grown from the boron as components can be obtained by the thermal plasma vapor growth method. In this document, unless otherwise specified, boron, which is simply referred to as “boron (B),” “boron,” or “B,” means as follows: boron that exists as a single element that remains inside BNF without reacting with nitrogen during the manufacturing process of BNNT, and the boron is distinguished from boron nitride which forms BNNT or BNF (that is, boron that exists as a compound).

When boron nitride nanomaterial is used as a filler of a composite material, boron included in boron nitride fullerenes is liable to be an origin of material defects in the composite material. Therefore, boron nitride nanomaterial in which boron is removed from boron nitride fullerenes is preferred as a filler.

As for a method of removing boron from boron nitride nanomaterials, Non Patent Literatures 1 and 2 suggest heat treating boron nitride nanomaterials, obtained by the thermal plasma vapor growth method, oxidizing boron and dissolving the produced boron oxide in a solvent, such as water or alcohol, thereby removing boron.

However, according to studies by the present inventors, it has been revealed that there is a possibility that the boron removing method suggested by Non Patent Literatures 1 and 2 cannot oxidize boron sufficiently, and thus boron that has not been oxidized is not removed. In other words, the suggestion made by Non Patent Literatures 1 and 2 may oxidize a surface layer from the surface of boron to a certain depth by a heat treatment, but not oxidize the central part which is located deeper than the certain depth, thereby leaving boron (B) as it is, in boron nitride fullerenes. As such, according to the boron removing method in Non Patent Literatures 1 and 2, boron oxide located on the surface layer can be removed by dissolving the boron oxide in a solvent, but boron (B) existing in an inner layer than boron oxide may not be removed by dissolving since its solubility to a solvent, such as water or alcohol, is low.

Therefore, an object of the present invention is to provide a method of manufacturing a boron nitride nanomaterial, in which boron can be removed more certainly from a boron nitride nanomaterial that is manufactured using, for example, the thermal plasma vapor growth method, as well as a boron nitride nanomaterial.

### Solution to Problem

A method of manufacturing a boron nitride nanomaterial according to the present invention comprises: a nanomaterial producing step of producing a boron nitride nanomaterial in which a boron grain(s) is included in a boron nitride fullerene; an oxidation treatment step of forming boron oxide on at least a surface layer of the boron grain(s) by exposing the boron nitride nanomaterial to an oxidizing environment; and a mechanical shock imparting step of applying a mechanical shock for removing the boron grain(s) on the boron nitride nanomaterial that has undergone the oxidation treatment step. In the oxidation treatment step, the boron nitride nanomaterial is immersed in a solvent that dissolves the boron oxide.

In the mechanical shock imparting step of the present invention, preferably, the mechanical shock is repeatedly applied.

In addition, in the mechanical shock imparting step of the present invention, preferably, the mechanical shock is applied by agitating a mixture comprising the boron nitride nanomaterial, the solvent and a shock medium.

In the oxidation treatment step of the present invention, preferably, the boron nitride nanomaterial is subjected to a heat treatment under an oxidizing atmosphere. This heat treatment is preferably performed in a temperature range of 700 to 900° C.

In the manufacturing method of the present invention, preferably, the method further comprises a rinsing step of rinsing the boron nitride nanomaterial that has undergone the mechanical shock imparting step in a solvent that dissolves the boron oxide.

The present invention provides a purifying method, wherein, from a boron nitride nanomaterial having a boron nitride fullerene that includes a granular boron oxide or a granular composite with an outer layer composed of boron oxide and an inner layer composed of boron, which is surrounded by the outer layer. This purifying method is characterized by that a mechanical shock is applied to the boron nitride nanomaterial immersed in a solvent that dissolves the boron oxide.

A boron nitride nanomaterial comprising a boron nitride fullerene, obtained by the above manufacturing method or purifying method is characterized by having a boron content of 18.0 mass % or less as measured by X-ray photoelectron spectroscopy. The boron content herein derives from free boron and/or simple boron oxide.

Moreover, a method of manufacturing a composite material in which a boron nitride nanomaterial having a boron nitride fullerene is dispersed in a metallic material or a polymeric material is provided. The boron nitride nanomaterial in this manufacturing method for the composite material can be obtained through steps of: immersing, in a solvent that dissolves boron oxide, a boron nitride nanomaterial having a boron nitride fullerene that includes a granular composite or a single grain; applying a mechanical shock to the boron nitride nanomaterial; and removing the granular composite or the single grain.

The granular composite includes an outer layer which is composed of boron oxide and an inner layer which is surrounded by the outer layer and is composed of boron. The single grain is composed of boron oxide.

### Advantageous Effects of Invention

According to the present invention, when a boron nitride nanomaterial is produced in a state where a boron grain(s) is included in a boron nitride fullerene, a mechanical shock is applied to the boron nitride nanomaterial in which boron oxide is formed on at least a surface layer of the boron grain(s) in a solvent that dissolves boron oxide. By doing this, boron is efficiently reduced from the boron nitride fullerenes by one or both of elution and release, and preferably boron can be removed completely.

### BRIEF DESCRIPTION OF DRAWINGS

FIG. 1 shows a flow diagram indicating procedures of a manufacturing method of boron nitride nanomaterial, pertaining to one embodiment of the present invention.

FIG. 2A and FIG. 2B each show a transmission electron micrograph of boron nitride nanomaterial produced by the thermal plasma vapor growth method, FIG. 2A and FIG. 2B showing different fields of vision.

FIG. 3A and FIG. 3B each show a transmission electron micrograph of boron nitride nanomaterial produced by the thermal plasma vapor growth method, FIG. 3A and FIG. 3B showing different fields of vision.

FIG. 4 shows a diagram indicating three components of boron nitride nanomaterial produced by the thermal plasma vapor growth method.

FIGS. 5A to 5C show diagrams schematically indicating behaviors of boron nitride nanomaterial in a heat treatment step.

FIGS. 6A to 6G show diagrams indicating behaviors of the boron nitride fullerene in a mechanical shock imparting step.

FIG. 7A and FIG. 7B each show a transmission electron micrograph of boron nitride nanomaterial that have successively undergone heat treatment, bead-milling treatment, and ethanol rinsing treatment in the present example, FIG. 7A and FIG. 7B showing different fields of vision.

FIG. 8 shows a table of results of Examples and Comparative Example.

FIG. 9A and FIG. 9B each show a transmission electron micrograph of boron nitride nanomaterial pertaining to Comparative Example, FIG. 9A and FIG. 9B showing different fields of vision.

### DESCRIPTION OF EMBODIMENTS

From now on, a manufacturing method of boron nitride nanomaterial, pertaining to one embodiment of the present invention, will be described with reference to the appended drawings.

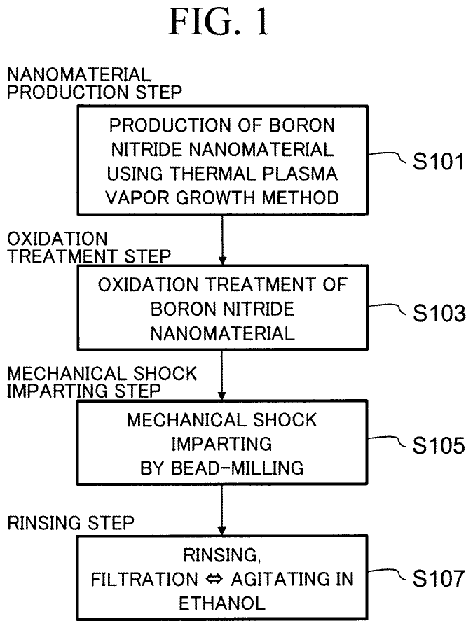

The manufacturing method pertaining to the present embodiment comprises a nanomaterial producing step for producing boron nitride nanomaterial (S101), an oxidation treatment step of the produced boron nitride nanomaterial (S103), a mechanical shock imparting step for removing boron (B) from the oxidation treated boron nitride nanomaterial (S105), and, as a preferable step, a rinsing step of the boron nitride nanomaterial onto which the mechanical shock is imparted (S107), as shown in FIG. 1. The manufacturing method pertaining to the present embodiment has a characteristic in which boron is efficiently removed from boron nitride fullerenes by performing the mechanical shock imparting step after the oxidation treatment step. In addition, the manufacturing method of the present embodiment preferably has a characteristic in which a higher retention temperature in the oxidation treatment step of the boron nitride nanomaterial is set compared to Non Patent Literatures 1 and 2.

In the following, each step of the manufacturing method of the present embodiment will be described in order.

### Producing Step of Boron Nitride Nanomaterial (FIG. 1, S101)

In the present embodiment, boron nitride nanomaterial is produced by the thermal plasma vapor growth method. Since the thermal plasma vapor growth method is described in detail in Non Patent Literatures 1 and 2, its description is omitted, and boron nitride nanomaterial that is produced will be described here.

The boron nitride nanomaterial produced by the thermal plasma vapor growth method has boron nitride nanotubes, and boron nitride fullerenes that have granular boron as an impurity. The present embodiment has an object to remove this boron from boron nitride fullerenes.

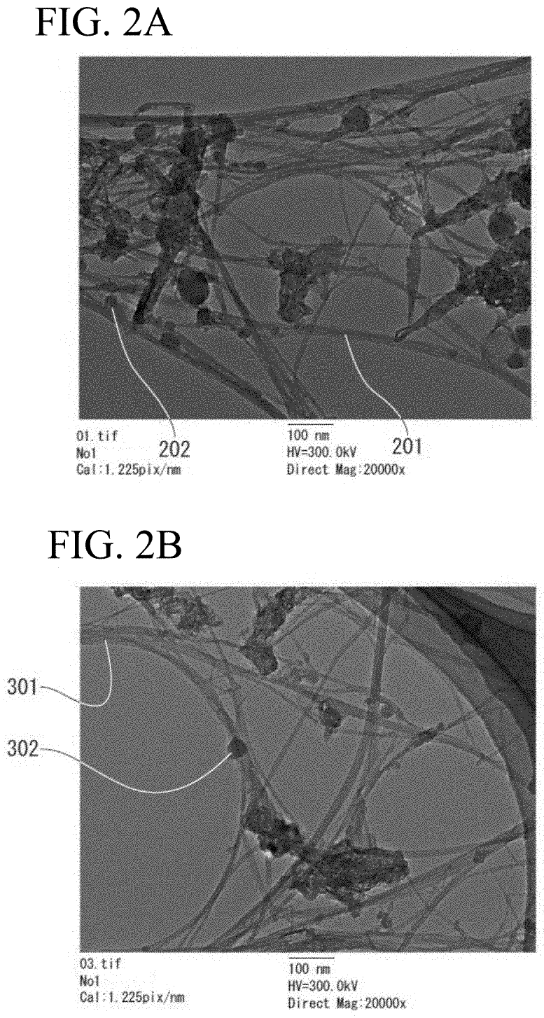

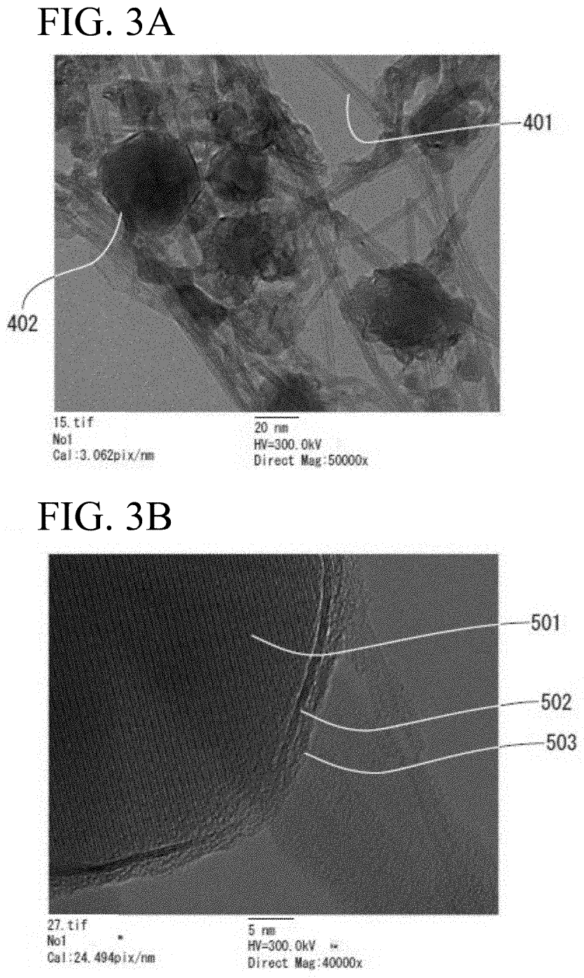

Photographs by a transmission electron micrograph (TEM) of the boron nitride nanomaterial produced by the thermal plasma vapor growth method are shown in FIGS. 2 and 3.

In FIG. 2A, thread-like ones are boron nitride nanotubes 201, and granular ones with stuffed inside are boron 202. Here, if the gray color is darker, boron is present and the boron nitride fullerene, which is omitted from the figure, is expressed as “with stuffed inside”. The same applies thereafter. It is rare for boron nitride nanotubes to be present alone, and in most cases, several or tens of boron nitride nanotubes are present as a bundle. Furthermore, it is common for a bundle to be entangled with another bundle in a complicated way.

FIG. 2B is a transmission electron micrograph in a different field of vision from FIG. 2A. As with FIG. 2A, thread-like ones are boron nitride nanotubes 301, and granular ones with stuffed inside are boron 302.

FIG. 3A is a transmission electron micrograph with a higher magnification compared to FIGS. 2A and 2B. Similarly, thread-like ones are boron nitride nanotubes 401, and granular ones with stuffed inside are boron 402. Boron 402 appears to be covered with thread-like substances.

FIG. 3B is a transmission electron micrograph of a boron grain with a higher magnification compared to FIGS. 2A, 2B and 3A. Boron 501 is included in a boron nitride fullerene 502. A boron nitride fullerene 502 includes a plurality of layers. Furthermore, on the surface of the boron nitride fullerene 502, an amorphous component 503 made from nitrogen, boron and hydrogen is attached. The boron nitride fullerene 502 has a shape like a closed oval sphere, and boron 501 is densely accommodated inside of the fullerene. In the boron nitride fullerene 502, defects are inevitably present that penetrate its inside and outside, although the defects are not explicitly shown in FIG. 3B. From these defects, oxygen intrudes into the inside, gradually oxidizing the included boron from the surface toward the central part.

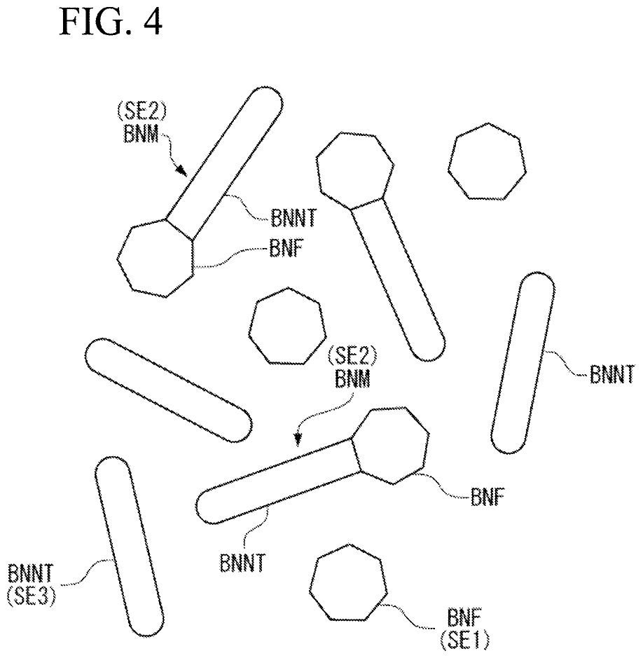

When boron nitride nanotubes are to be manufactured using the thermal plasma vapor growth method, boron nitride nanotubes (BNNTs) grow from the boron that has been precipitated in a space, and boron nitride fullerenes (BNFs), which have similar properties as boron nitride nanotubes, is also formed around boron. Normally, as shown in FIG. 4, there are three types of components of boron nitride nanomaterial (BNM) produced by the thermal plasma vapor growth method, as follows.

The component SE1 is composed of a single boron nitride fullerene BNF that includes boron (B). The component SE2 is composed of a boron nitride fullerene BNF that includes boron (B) and a boron nitride nanotube BNNT that is linked with the boron nitride fullerene BNF. The component SE3 is composed of a single boron nitride nanotube BNNT. The components SE1 to SE3 exist independently of each other. The abundance ratio of each component of the boron nitride nanomaterial shown in FIG. 4 does not necessarily reflect that of the actual boron nitride nanomaterial in an accurate way. In the present invention, the object from which boron is removed is boron nitride nanomaterial (BNM) that comprises at least either one or both of the component SE1 and component SE2. A manufacturing method of the boron nitride nanomaterial (BNM) is not limited to the thermal plasma vapor growth method.

### Oxidation Treatment Step of Boron Nitride Nanomaterial (FIG. 1, S103)

Next, the boron nitride nanomaterial with boron nitride fullerenes are subjected to an oxidation treatment step. This oxidation treatment is performed for the purpose of oxidizing boron included in boron nitride fullerenes by exposing them to an oxidizing environment. This oxidation treatment is also performed for the purpose of enlarging defects that have been present in boron nitride fullerenes from the initial state when they are produced. In order to promote the oxidation and enlarge defects, it is recommended to set a retention temperature in the oxidation treatment step on the high side. In the following, specific contents of the oxidation treatment step will be described.

### Purpose of Oxidation Treatment Step

It is an object for the oxidation treatment step to oxidize boron, but it is not easy to oxidize the entire granular boron included in boron nitride fullerenes to form boron oxide. This is because the closer to the center of boron, the harder it becomes for oxygen to intrude, and non-oxidized boron tends to remain in the central part. As such, it is most preferable for the entire boron to be oxidized in the oxidation treatment step of the present embodiment from the view point of removal of boron in the next mechanical shock imparting step; however, it is tolerated that at least a part of boron is oxidized, but another part of boron remains non-oxidized. As an example, it is preferred that ½ or more by volume of a boron grain are oxidized, and it is more preferred that ¾ or more by volume of a boron grain are oxidized.

It is further advantageous for the removal of boron when the boron oxide produced by oxidizing boron is melted, and thus, this point will be described. Boron oxide produced by oxidation treating boron is expanded in volume, relative to boron. The melting point of boron oxide is approximately 450° C., and therefore, by setting the oxidation treatment temperature at 450° C. or higher, boron oxide is melted inside of fullerenes. It is believed that a part of melted boron oxide cannot be retained inside of the fullerene, and is eluted to the outside of the boron nitride fullerene through defects and adhered to the outer surface of the fullerene. Boron oxide outside of the boron nitride fullerene can be further readily removed by melting, compared to boron oxide that remains inside.

As previously mentioned, in addition to the oxidation of boron, the oxidation treatment step has an object to enlarge defects that have been present in boron nitride fullerenes from the initial state when they are produced. It is believed that in the next mechanical shock imparting step, boron inside of the boron nitride fullerene is released to the outside through enlarged defects, thereby promoting the removal of boron. In this document, “elution” refers to the fact that boron oxide is dissolved and then released outside the boron nitride fullerene, while “release” refers to the fact that solid boron is released outside the boron nitride fullerene.

Defects of the boron nitride fullerene are inevitably present from the initial state when the boron nitride nanomaterial is produced, and in consideration of efficiently performing the removal of boron from the boron nitride fullerene, it is desirable to further enlarge the existing initial defects. In the oxidation treatment step, the higher the heat treatment temperature is, the more easily the existing initial defects are enlarged. A suitable heat treatment temperature for the defect enlargement is 800° C. or higher.

The defect enlargement of the boron nitride fullerene also occurs via oxidation of boron. In other words, when boron is oxidized, the volume expansion occurs, thereby imparting stress to the boron nitride fullerene from the inside to the outside. Through this, the existing initial defects are enlarged.

### Heat Treatment Atmosphere

The oxidation treatment step aims at oxidizing boron, and thus, the treatment is performed by heating under an oxidizing atmosphere, which is an example of the oxidizing environment. A typical example of the oxidizing atmosphere is atmospheric air, but the heat treatment can be performed under an atmosphere that contains more oxygen than atmospheric air, and the heat treatment can be performed under an atmosphere that contains less oxygen than atmospheric air. If the heat treatment is performed at the same retention temperature, a desired oxidation state can be obtained in a shorter time when the heat treatment is performed under an atmosphere that contains much oxygen.

### Heat Treatment Temperature

The heat treatment temperature should be a temperature that can oxidize boron, but it is preferred to set the temperature range between 700° C. and 900° C. because the heat treatment becomes longer if the temperature is low. For example, when the treatment temperature is 700° C., it is proper for the treatment time to be 5 hours, and when the treatment temperature is 900° C., it is proper for the treatment time to be 1 hour. Less than 700° C. is not preferred because the heat treatment time becomes too long. When the temperature exceeds 900° C., this is not preferred because a part of boron nitride nanotubes are burned, thereby decreasing the yield.

It is understood that the burning temperature of boron nitride nanomaterial that has a perfect crystal structure in atmospheric air is at least 1000° C. or higher. In contrast, the boron nitride nanotube that has many crystal defects is burned at a temperature of 700° C. to 900° C. Therefore, by performing the heat treatment at this temperature range, effects of removing boron nitride nanotubes that have many crystal defects by burning and of selecting boron nitride nanotubes with higher crystallinity can be achieved.

It is noted that the heat treatment follows a series of courses, namely, a temperature rising area, a temperature retaining area, and a temperature descending area, and the heat treatment temperature in the present embodiment refers to the temperature in the retaining area. However, the temperature in the retaining area is not necessarily strictly constant, and may rise and descend within a predetermined range.

The boron nitride nanomaterial comprises an element in which the mass increases during the course of the oxidation, and another element in which the mass decreases, and these elements cancel each other, increasing the mass by about 30%. The element in which the mass increases includes the oxidation of boron. The element in which the mass decreases is believed to be disappearance of defect parts in the boron nitride nanotube or boron nitride fullerene by burning, and disappearance of the existing initial amorphous component by burning.

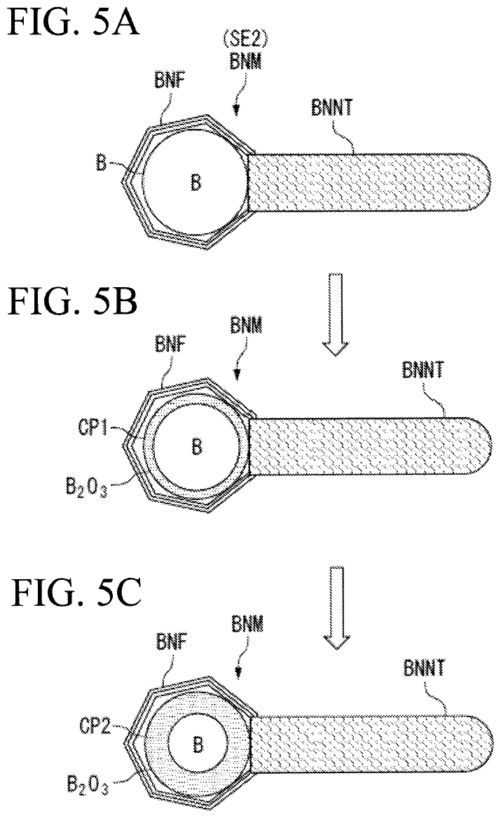

As a representative of a boron nitride nanomaterial, FIG. 5 shows a boron nitride nanomaterial BNM which is the component SE2 of FIG. 4. With reference to FIG. 5, behaviors of boron nitride nanomaterial in the oxidation treatment step are described for the component SE2.

As shown in FIG. 5A, the boron nitride nanomaterial BNM pertaining to the component SE2 comprises a boron nitride nanotube BNNT and a boron nitride fullerene BNF, and inside the boron nitride fullerene BNF, granular boron B is present prior to the oxidation treatment.

When the oxidation treatment begins, oxygen that has passed through the boron nitride fullerene BNF spreads from the surface of boron B toward the inside, producing boron oxide B₂O₃ on the surface layer of boron B. Through this, boron B becomes a granular composite CP1 with an outer layer composed of boron oxide and an inner layer composed of boron, which is surrounded by the outer layer, as shown in FIG. 5B. The volume of the granular composite CP1 increases relative to boron B before the oxidation treatment, applying stress from the inside to the outside of the boron nitride fullerene BNF. This pressure provides strain to the boron nitride fullerene BNF, thereby enlarging initially existing defects.

The melting point of boron oxide is approximately 450° C., and therefore, when the heat treatment temperature is from 700 to 900° C., the produced boron oxide is melted during the course of the oxidation treatment step. Melted is boron oxide within a range in the vicinity of the surface of the granular composite CP. A part of the melted boron oxide B₂O₃ is eluted to the outside of the boron nitride fullerene BNF through defects of the boron nitride fullerene BNF, and adhered to the outer peripheral surface of the boron nitride fullerene BNF. Note that illustration of this boron oxide is omitted. Boron oxide, other than those eluted, remains inside the boron nitride fullerene. The melted boron oxide solidifies when the oxidation treatment finishes and the temperature reaches less than the melting point.

During the course of the oxidation treatment, boron nitride nanotubes themselves do not change physically and chemically, but as previously mentioned, boron nitride nanotubes that have many crystal defects are burned and disappear.

As described above, a low purity boron nitride nanomaterial after the oxidation treatment comprises a boron nitride nanotube BNNT and a boron nitride fullerene BNF, as shown in FIG. 5C. A granular composite CP2 is present inside the boron nitride fullerene BNF, and non-oxidized boron B, which is smaller than the boron B shown in FIG. 5B, remains inside the granular composite. In addition, on the outer periphery of the boron nitride fullerene BNF, boron oxide B₂O₃ is adhered, illustration of which is omitted. This boron nitride nanomaterial is the object to be treated in the next mechanical shock imparting step.

Note that in the above, the example is shown where the boron nitride nanomaterial is exposed to and heat treated in the dry oxidizing environment comprising oxygen, but boron may be oxidized by exposing the boron nitride nanomaterial to a wet oxidizing environment using liquid.

### Mechanical Shock Imparting Step (FIG. 1, S105)

The mechanical shock imparting step is performed for the purpose of removing boron and boron oxide from a boron nitride fullerene for the purification of the boron nitride fullerene. The mechanical shock imparting step is preferably performed under a wet environment with a solvent that can dissolve boron oxide. Boron oxide dissolves in alcohols, such as ethanol, methanol, and isopropyl alcohol, or in water. As the solvent, it is preferable to use those that can dissolve boron oxide and boron. Removal of boron is achieved in connection with the following three elements.

element 1: By repeatedly imparting mechanical shock power to the granular composite via a medium, dissolution of boron oxide in a solvent is promoted.

element 2: Even if non-oxidized boron remains in the boron nitride fullerene, by repeatedly imparting mechanical shock power, the residual boron moves inside the boron nitride fullerene. While moving, the residual boron is released to the outside of the boron nitride fullerene from a defect of the boron nitride fullerene, the size of which is approximately the same as the residual boron, or from a bigger defect.

element 3: Boron that is released to the outside of the boron nitride fullerene is subjected to the mechanical shock power and becomes easily oxidized in a solvent, and all of boron eventually becomes easily dissolved in a solvent.

From the above, it becomes easy to remove boron from the boron nitride nanomaterial comprising boron, and it becomes possible to obtain a boron nitride nanomaterial that does not substantially contain boron.

As an equipment by which the mechanical shock imparting step is performed, the so-called pulverizer or ultrafine pulverizer can be used. As a pulverizer, container driven mills, such as a planet mill (ball mill) and a vibrating mill, can be used as well as a jet mill. In addition, as an ultrafine pulverizer, medium agitating mills, such as an attritor and bead mill, can be used.

Bead mills are preferable as an equipment for the mechanical shock imparting step.

The bead mill is a medium agitating mill using beads as a grinding medium. There are dry bead mills and wet bead mills, but a wet bead mill is employed in the present embodiment. Beads are a spherical, grinding medium with the smaller diameter of 0.03 to 2 mm, compared with balls that are used as a grinding medium in, for example, planet mills. The material of beads is appropriately specified among ceramics, metal and glass depending on the object to be crushed, but in the present embodiment, ZrO₂ (zirconia) is suitably used.

In the bead mill, a slurry which is a mixture of the object to be crushed and liquid is placed in a crushing chamber (vessel), along with beads, and is agitated. In the crushing chamber, a disc is provided as an agitation mechanism. With the centrifugal force generated by rotating this disk at a high speed, beads are provided with energy, and catch the object to be crushed and repeatedly impart mechanical shock. The energy by the centrifugal force varies among models, sizes, etc. of the bead mill, but it is tens to hundreds of times the planet mill, which is significantly bigger.

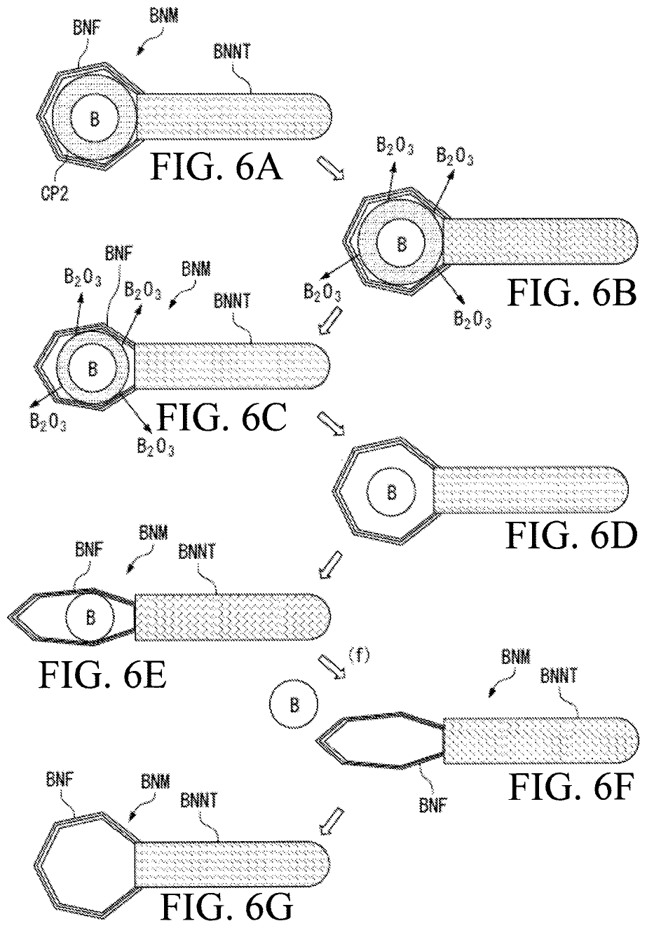

With reference to FIG. 6, behaviors of boron nitride nanomaterial BNM in the mechanical shock imparting step are described.

As shown in FIGS. 6A and 6B, the boron nitride nanomaterial BNM has a boron nitride fullerene BNF including boron and boron oxide that have undergone the oxidation treatment, and the boron nitride nanomaterial BNM (object to be crushed) is charged in, for example, a bead mill. In the bead mill, a solvent that can dissolve boron oxide is stored, and the boron nitride nanomaterial is immersed in this solvent. The crushing chamber accommodating a mixture comprising the solvent, the boron nitride nanomaterial, and beads as a shock medium, is rotated to agitate the mixture, thereby imparting mechanical shock to the boron nitride nanomaterial. In the boron nitride fullerene, defects that penetrate its inside and outside are provided, and through these defects, the solvent invades inside the boron nitride fullerene. Therefore, boron oxide present on the surface layer of the granular composite CP2 is dissolved and eluted to the outside of the boron nitride fullerene. Note that the boron oxide B₂O₃ adhered to the outer periphery of the boron nitride fullerene through the oxidation treatment step is also dissolved in the solvent.

FIG. 6B shows a boron nitride fullerene BNF that keeps its original form, but by the impact of beads, the boron nitride fullerene BNF repeats deformation (FIG. 6C) and recovery (FIG. 6D). Through this, all of the boron oxide present on the surface layer of the granular composite CP2 is dissolved, and it is estimated that only boron B remains inside the boron nitride fullerene BNF, as shown in FIG. 6D. “Deformation” here has a concept that includes contraction to a similar shape, in addition to a change in shape from the initial shape. “Recovery” means that the deformed one returns to the shape before the deformation, but it is not required to completely return to the shape before the deformation.

After this, the boron nitride fullerene BNF still repeats the deformation and recovery, and boron B is released to the outside through the defects (not shown) introduced into the boron nitride fullerene BNF, and boron can be removed from the inside of the boron nitride fullerene BNF, as shown in FIGS. 6E, 6F and 6G.

In the above description using FIG. 6, in order to make each element clear, the description was made in the order where the dissolution of boron oxide from the granular composite CP2 is first achieved, and then the remaining boron B is released to the outside of the boron nitride fullerene. However, in fact, in the mechanical shock imparting step, the granular composite CP2 can be released to the outside of the boron nitride fullerene prior to the completion of the dissolution of boron oxide from the granular composite CP2.

Moreover, in the above description, the example where a single boron nitride nanomaterial is targeted, and boron, including the part where boron oxide is produced, is removed. However, when the oxidation treatment step and the mechanical shock imparting step are actually performed on a number of boron nitride nanomaterials, it cannot be denied that boron remains in the boron nitride fullerene in some of the boron nitride nanomaterials. Even in this case, as long as boron is removed from the boron nitride fullerene in the majority of the boron nitride nanomaterials, the effects according to the present embodiment can be enjoyed.

### Rinsing Step (FIG. 1, S107)

Even after the mechanical shock imparting step, a possibility cannot be denied where a small amount of boron or boron oxide that is eluted and released to the outside of the boron nitride fullerene still remains in the boron nitride nanomaterial. Therefore, in order to remove the remaining boron or boron oxide, a rinsing step is preferably performed. As an example, the rinsing step is performed in the following procedures.

After the mechanical shock imparting step, a suspension in ethanol comprising the boron nitride nanomaterial is filtered by a filter paper. The substance (residual) remaining on the filter paper is placed in clean ethanol, and a treatment of applying ultrasonic vibration and stirring is conducted. The rinsing step is carried out by repeating these filtration and ultrasonication in ethanol several times. Boron oxide is dissolved in an ethanol solution, but by applying ultrasonic vibration, the dissolution of boron oxide in ethanol can be promoted.

### EXAMPLES

In the next part, the present invention will be described based on a specific example.

In the present example, a boron nitride nanomaterial (sample) produced by using the thermal plasma vapor growth method is subjected to the oxidation treatment step, the mechanical shock imparting step and the rinsing step shown below to obtain a boron nitride nanomaterial in which no boron is substantially included.

### Oxidation Treatment Step

Into a vessel made of alumina (Al₂O₃), 10.0 g of the sample is placed, and this vessel is inserted into a heat treatment furnace composed of quartz tubes, the inside of which is set to be an air atmosphere. In this condition, heat treatment was performed where the sample was retained at 700° C. for 5 hours, retained at 800° C. for 3 hours, and retained at 900° C. for 1 hour.

### Mechanical Shock Imparting Step

The sample after the oxidation treatment (10.0 g) was placed and dispersed in 500 mL of ethanol as a solvent that was maintained at 20° C. In order to improve the degree of dispersion of the sample, ultrasonication was conducted to the solvent just for 30 minutes. After that, mechanical shock was imparted to the sample, using a bead mill device.

Continuous treatment for 5 hours was performed under the condition where the beads used have a diameter of 200 and are made of ZrO₂, and the circulating flow rate of the solvent in the bead mill device is 8 m/s.

### Rinsing Treatment Step

The suspension containing the sample in ethanol, the sample having undergone the mechanical shock imparting step, was filtered. Then, the substance (sample) remaining on the filter paper was placed in 500 mL of clean ethanol, and ultrasonication was conducted just for 30 minutes. The filtration and ultrasonication in ethanol were repeated several times.

### Comparative Example

The boron nitride nanomaterial is used as Comparative Example, that was obtained through the same oxidation treatment step and rinsing treatment step as Example, except that the mechanical shock imparting step is not performed.

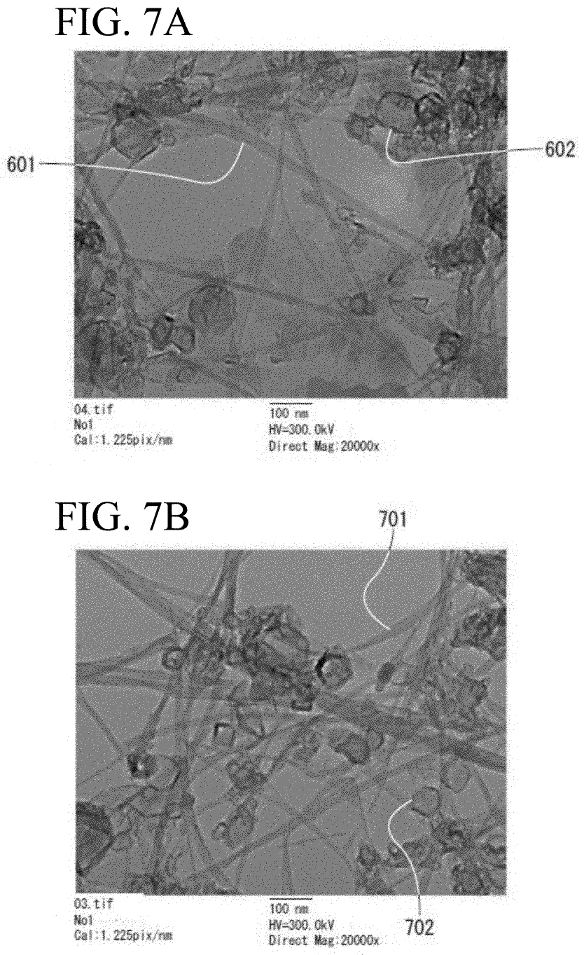

FIG. 7 shows transmission electron micrographs of boron nitride nanomaterial pertaining to Example.

In FIG. 7A, thread-like ones are boron nitride nanotubes 601, and those like a hollow, oval sphere are boron nitride fullerenes 602, from which boron is removed. The boron nitride fullerene 602 in FIG. 7A corresponds to the boron 202 in FIG. 2A, but it is visually recognizable that no boron probably exists in the boron nitride fullerene 602 in which the gray color is so light. In FIG. 7B with a different field of vision, similarly, thread-like ones are boron nitride nanotubes 701, and those like a hollow, oval sphere are boron nitride fullerenes 702, from which boron is removed.

In this way, it was confirmed that a boron nitride nanomaterial is obtainable without substantially including boron, which is an impurity, by performing a series of treatments, namely the above described oxidation treatment step, mechanical shock imparting step, and rinsing treatment step.

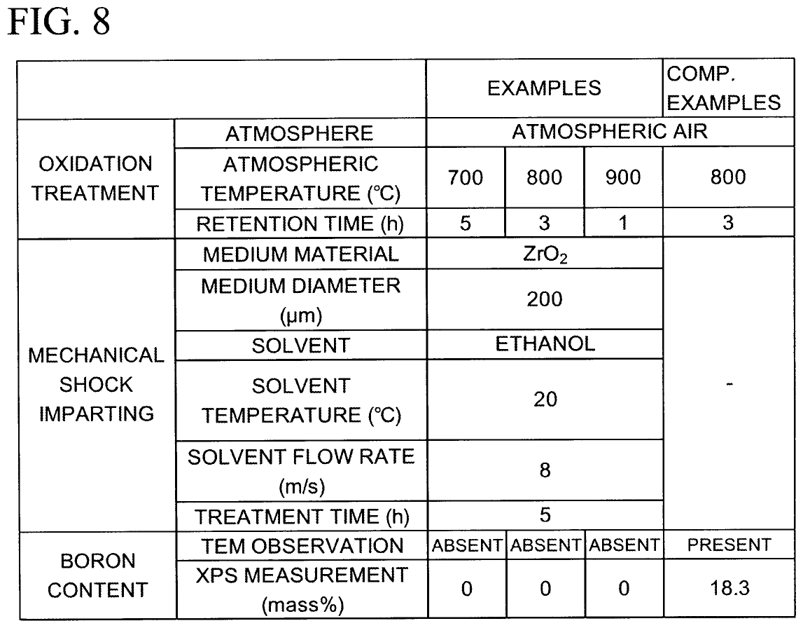

As a result of analysis on the boron content of the boron nitride nanomaterial pertaining to Example by the XPS analysis (XPS=X-ray photoelectron spectroscopy) under the following condition, boron was not detected. This result is shown in FIG. 8, along with the result of Comparative Example.

### XPS Analysis Condition

Analytical instrument: scanning X-ray photoelectron spectroscopic device PHI5000 VersaProbe II, manufactured by ULVAC-PHI, INCORPORATED.

X-ray source: monochrome Al

X-ray diameter: 100 μm

Photoelectron extraction angle: 45° (from sample normal line)

Measurement area: 500×250 μm²

Charge neutralization: present

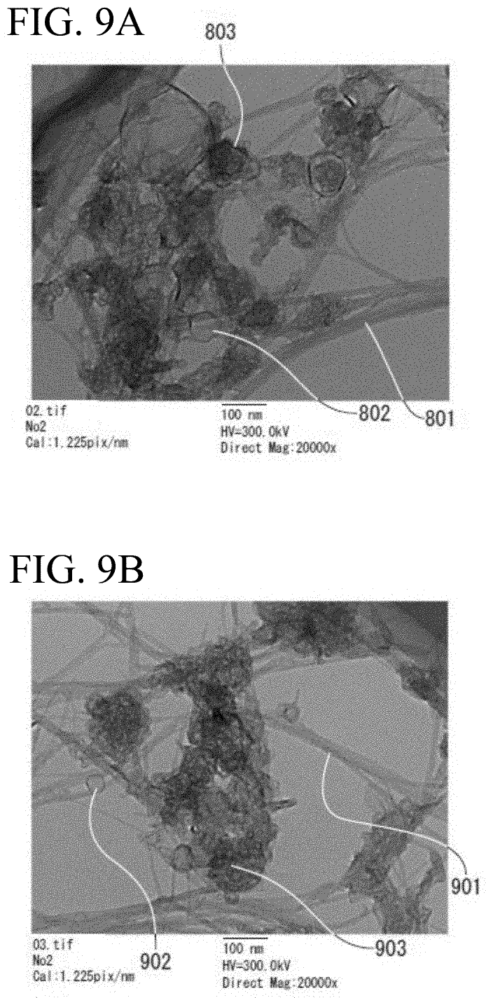

FIG. 9 shows transmission electron micrographs of boron nitride nanomaterial pertaining to Comparative Example.

In FIG. 9A, thread-like ones are boron nitride nanotubes 801; those like a hollow, oval sphere are boron nitride fullerenes 802, from which boron is removed; and those with stuffed inside are boron nitride fullerenes 803, which contain residual boron.

In FIG. 9B, similarly, thread-like ones are boron nitride nanotubes 901; those like a hollow, oval sphere are boron nitride fullerenes 902, from which boron is removed; and those with stuffed inside are boron nitride fullerenes 903, which contain residual boron.

In this way, without mechanical shock imparting, boron remains inside the boron nitride fullerene. As a result of the XPS analysis, the boron content of the boron nitride nanomaterial of the Comparative Example was 18.3 mass %.

### Production and Evaluation of Composite Material

By using the boron nitride nanomaterial of the present invention, it is possible to produce a metal composite material that uses the boron nitride nanomaterial as the dispersed phase and a metal as the matrix, as well as a polymeric composite material that uses the boron nitride nanomaterial as the dispersed phase and a polymeric material as the matrix. In the following Examples and Comparative Examples, by way of example, aluminum composite materials and fluorine resin composite materials were produced.

### Aluminum Composite Material

### Example 1

A powder mixture was prepared in which one part by mass of the boron nitride nanomaterial that was obtained in Example (the atmospheric temperature of 800° C. in the oxidation treatment) was mixed with Si powder, and this powder mixture was placed in 99 parts by mass of molten aluminum. By solidifying the molten metal in this mixture, an aluminum composite material was produced in which the boron nitride nanomaterial was the dispersed phase and aluminum was the matrix.

### Comparative Example 1

With the exception that the boron nitride nanomaterial obtained in Comparative Example was used instead of the boron nitride nanomaterial obtained in Example, an aluminum composite material was produced in the same way as Example 1.

### Tensile Strength

The aluminum composite material according to Example 1 has a tensile strength improved by 35.0%, compared to the aluminum composite material according to Comparative Example 1. Note that for the matrix of metal composite materials, titanium, nickel, iron, or alloys thereof can be used, other than aluminum.

### Fluorine Resin Composite Material

### Example 2

By mixing an organic solution in which the boron nitride nanomaterial obtained in Example (the atmospheric temperature of 800° C. in the oxidation treatment) was dispersed, with an organic solution of a fluorine containing resin, and then removing organic solvents by drying, a fluorine resin composite material was produced in which the boron nitride nanomaterial was the dispersed phase and the fluorine containing resin was the matrix. The content of the boron nitride nanomaterial is 1 mass %.

### Comparative Example 2

With the exception that the boron nitride nanomaterial obtained in Comparative Example was used instead of the boron nitride nanomaterial obtained in Example, a fluorine resin composite material was produced in the same way as Example 2.

### Tensile Strength Retention

The fluorine resin composite material according to Example 2 has a tensile strength retention improved by 20 points, compared to the fluorine resin composite material according to Comparative Example 2. Note that for the matrix of polymeric composite materials, thermosetting resins, thermoplastic resins, chlorine, iodine or bromine containing resins, or any mixture thereof can be used, other than fluorine resins.

The tensile strength retention Rₜ and its improvement factor Rᵢ are calculated as follows:

Rₜ=T₁/T₀×100

Rₜ: Tensile strength retention (%)

T₀: Mean value of tensile strength before aging test

T₁: Mean value of tensile strength after aging test

Aging test: test pieces were retained in a heat aging tester at 250° C. for 4 days

Rᵢ=Rₜₑ−R_{tc}

Rᵢ: Improvement factor of tensile strength retention (point)

Rₜₑ: Tensile strength retention of composite material of Example (%)

R_{tc}: Tensile strength retention of composite material of Comparative Example (%)

### Effect 1

Effects achieved by the manufacturing method of boron nitride nanomaterial, pertaining to the present embodiment will be described.

In the present embodiment, mechanical shock imparting is repeated to the granular composite CP2 with boron oxide formed on the surface layer thereof under a wet environment comprising a solvent that can dissolve boron oxide. As such, the boron oxide formed on the surface layer of the granular composite CP2 can be dissolved more quickly compared to the exposure treatment to the solvent alone. In addition, the mechanical shock promotes the release of boron that remains after the removal of boron oxide, to the outside of the boron nitride fullerene. It is estimated that the boron released to the outside of the boron nitride fullerene is, because it is directly subjected to the mechanical shock, progressively oxidized by the solvent, and that the dissolution quickly takes place.

From the above, according to the present embodiment, the manufacturing method of boron nitride nanomaterial is achieved that can remove all of the boron included in boron nitride fullerenes or that can at least reduce its amount significantly.

### Effect 2

By adding the boron nitride nanomaterial to a metallic material or a polymeric material, a fiber reinforced composite material can be produced. In the composite material, boron nitride fullerenes serve to minimize bundling of boron nitride nanotubes, thereby improving their dispersibility. Conventional boron nitride nanomaterials including boron can improve the dispersibility of boron nitride nanotubes, but the boron included in the boron nitride fullerene has been liable to be an origin of material defects in the composite material. In contrast, the boron nitride nanomaterials according to the present embodiment can improve the dispersibility of boron nitride nanotubes, and furthermore, it does not easily become an origin of material defects in the composite material because the boron is removed from the boron nitride fullerene.

In the above, suitable embodiments of the present invention have been described, but unless they depart from the gist of the present invention, it is possible to make selection of configurations listed in the above described embodiments or to change them to other configurations in an appropriate way.

For example, the rinsing step is an optional step in the present invention, but it is not limited to the embodiments or Examples mentioned above. In short, as long as the remaining boron is oxidized and removed together with the remaining boron oxide by using a solvent that can dissolve boron oxide, specific means do not matter.

### REFERENCE SIGNS LIST

201, 301, 401, 601, 701, 801, 901 Boron nitride nanotube
202, 302, 402, 501 Boron
502, 602, 702, 802, 803, 902, 903 Boron nitride fullerene
B Boron
B₂O₃ Boron oxide
BNF Boron nitride fullerene
BNNT Boron nitride nanotube
BNM Boron nitride nanomaterial
CP Granular Composite

1. A method of manufacturing a boron nitride nanomaterial, wherein the method comprises:
a nanomaterial producing step of producing a boron nitride nanomaterial in which a boron grain(s) is included in a boron nitride fullerene;
an oxidation treatment step of forming boron oxide on at least a surface layer of the boron grain(s) by exposing the boron nitride nanomaterial to an oxidizing environment; and
a mechanical shock imparting step of applying a mechanical shock for removing the boron grain(s) from the boron nitride nanomaterial that has undergone the oxidation treatment step, while the boron nitride nanomaterial is immersed in a solvent that dissolves the boron oxide,
wherein the mechanical shock is applied by agitating a mixture comprising the boron nitride nanomaterial, the solvent and a shock medium in the mechanical shock imparting step.

2. The method of manufacturing a boron nitride nanomaterial according to claim 1, wherein the mechanical shock is repeatedly applied in the mechanical shock imparting step.

3. (canceled)

4. The method of manufacturing a boron nitride nanomaterial according to claim 1, wherein the boron nitride nanomaterial is subjected to a heat treatment under an oxidizing atmosphere in the oxidation treatment step.

5. The method of manufacturing a boron nitride nanomaterial according to claim 4, wherein the heat treatment is performed in a temperature range of 700 to 900° C.

6. The method of manufacturing a boron nitride nanomaterial according to claim 1 5, wherein the method further comprises a rinsing step of rinsing the boron nitride nanomaterial that has undergone the mechanical shock imparting step in a solvent that dissolves the boron oxide.

7. (canceled)

8. The method of manufacturing a boron nitride nanomaterial according to claim 1, wherein a boron content of the boron nitride nanomaterial is 18.0 mass % or less as measured by X-ray photoelectron spectroscopy.

9. A method of manufacturing a composite material in which a boron nitride nanomaterial having a boron nitride fullerene is dispersed in a metallic material or a polymeric material, wherein the boron nitride nanomaterial is obtained by the method according to claim 1.

10. (canceled)
